(19) United States
(12) Patent Application Publication
(10) Pub. No.: US 2010/0199732 A1
(43) Pub. Date: Aug. 12, 2010

(54) DEVICE AND METHOD FOR REMOVING A PIN STOPPER FROM A CHAMBER IN A LOCK HOUSING

(76) Inventor: Rahamim Komemi, Jerusalem (IL)

Correspondence Address: ROBERT G. LEV, 4766 MICHIGAN BLVD., YOUNGSTOWN, OH, 44505, US

(21) Appl. No.: 12/366,656

(22) Filed: Feb. 6, 2009

(51) Int. Cl. E05B 27/00

(52) U.S. Cl. 70/493

(57) ABSTRACT

A pin remover device for removing a pin stopper from the upper end of its chamber in a lock housing. The pin stopper has a hole bored from the end of the pin stopper open to the outside of said housing, at least partially along its longitudinal axis, and the device comprises a mechanism comprised of an insertion component for inserting into said hole, and for removing the pin stopper from the chamber.

### FIELD OF INVENTION

The present invention relates to the field of locks. In particular, the present invention relates to a pin tumbler locks. More particularly, the present invention relates to a device and method for unblocking a chamber jam in a lock housing.

### BACKGROUND OF INVENTION

A pin tumbler lock is a type of lock mechanism, typically used in cylinder locks, in which pins of varying lengths must be aligned in order to allow a lock plug cylinder to rotate. The pin tumbler cylinder lock comprises a housing having a cylindrical bore in which the lock plug cylinder is removably inserted. The lock plug cylinder contains a plurality of openings that are initially positioned beneath and aligned with a plurality of chambers in the housing. Each pin chamber contains a pin stack, which consists of at least: a key pin, located entirely within the lock plug cylinder; a driver pin, located partially within the cylinder and partially within the chamber, for preventing the cylinder from rotating; and, a compression spring, located within the chamber. When a correct key is inserted to the lock plug cylinder, the peaks and valleys of the key raise and lower the pin stack as appropriate, so as to situate the driver pins entirely within the chamber, thereby allowing the lock plug cylinder to rotate. In more complicated locks, additional pin stack elements may be present, such as spacer pins.

Malfunctions of a pin tumbler lock can take various forms. One example of a common malfunction is a chamber jam, wherein one or more components of the pin stack get stuck within the chamber of a lock housing. In this case, the only way of repairing the jam is to remove the lock plug and then remove the pin stack components through the empty cylindrical bore. Due to the small space of the bore, and the 90 degree angle of the chamber with respect to the bore, there exist difficulties when trying to remove the pin stack components from the chamber. Therefore, the lock is often discarded and replaced to avoid the difficulties involved with attempting to fix it.

The inventor of the present invention is aware of a single prior art solution for removing a jammed pin stack from a chamber. U.S. patent application Ser. No. 12/365,904, by the same inventor as the present invention discloses a novel lock housing comprising a series of holes bored through the housing, corresponding to the series of chambers in the housing. A pin stopper is removed from its chamber by inserting an elongated object through its corresponding hole, and pushing the pin stopper out of the upper end of the chamber, thereby allowing access to the chamber via the opening at the upper end, and bypassing the cylindrical bore. The present invention provides a solution for removing a pin stopper from its chamber, which is dissimilar in its features as well as in the process for removal of the pin stopper, as described herein below.

A prior art device which appears to be similar to the device of the present invention, but is actually dissimilar in function and feature, is disclosed in U.S. Pat. No. 5,276,951 to Gluszek. Gluszek describes a tubular lock puller for pulling the inner cylinder (or, lock plug) from the cylindrical bore of a lock housing. The tool comprises a cylindrical housing having a threaded main shaft having a front section with resilient fingers, which are radially compressible for insertion into the annular key passageway of the lock. Once inserted, the fingers return to their original position and engage the inner rim of the lock cylinder with their tips. A second shaft is slidable within the main shaft and carries a locking cup that retains the fingers in the lock engaging position. A threaded nut on the main shaft is rotated to withdraw the main shaft and forceably pull the inner cylinder from the lock. Although there is some resemblance in the procedure of removing the inner cylinder from the lock to that of the present invention, due to the difference in application, several essential components of the device of the present invention are not present, and are not obvious or anticipated based on Gluszek's patent.

U.S. Pat. No. 6,601,277 to Swanson, discloses a puller tool for bolt seals, for separating a security pin from a mated female part. The tool comprises an outer sleeve having an axially extending passage, a radial detent shoulder about the passage at one end of the sleeve, an actuating bolt including a threaded shank axially insertable into the passage and an enlarged head that engages the detent shoulder to prevent further insertion of the actuating bolt into the passage, and a puller member insertable into the passage from an opposite end of the sleeve. The puller is unrelated to the field of removing pin stack jams in a housing chamber. Thus, it is unreasonable to assume a man skilled in the art would think to make the necessary changes to the puller tool to operate similar to the device of the present invention.

It is therefore an object of the present invention to provide a device for removing a jam in the chamber of a lock housing.

It is a further object of the present invention to provide a device for removing the pin stopper from its chamber in a lock housing.

It is yet another object of the present invention to provide a device that is inexpensive to manufacture and requires little or no skill to operate.

Additional objects and advantages of the present invention are described in detail herein below.

### SUMMARY OF INVENTION

The present invention relates to a pin remover device for removing a pin stopper from the upper end of its chamber in a lock housing, wherein said pin stopper comprises a hole bored from the end of said pin stopper open to the outside of said housing, at least partially along its longitudinal axis, said device comprising a mechanism comprised of an insertion component for inserting into said hole, and for removing said pin stopper from said chamber.

Preferably, the hole comprises internal threading and the insertion component comprises external threading.

The mechanism of said device comprises:
an elongated shaft comprised of:
   a proximal handle portion;
   a central portion; and,
   a threaded distal tip;
a hollow screw in which said central portion is disposed, said hollow screw comprising:
   a head portion for gripping and rotating; and,
   a body portion having an external threading;
a lock saddle having internal threading for positioning along said body portion of said hollow screw; and,
a nut positioned around said distal tip, for preventing said shaft from sliding through said hollow screw;
wherein said threaded distal tip is the insertion component for inserting into the hole in the pin stopper.

Preferably, the diameter of the handle portion is larger than the internal diameter of the hollow screw, to prevent the shaft from sliding through said hollow screw.

Preferably, the proximal handle portion, the central portion and the threaded distal tip of the elongated shaft are manufactured as a single integral component.

The central portion of the shaft is preferably freely rotatable within the hollow screw.

The body portion of the hollow screw has counter-clockwise external threading.

### BRIEF DESCRIPTION OF THE FIGURES

In the drawings:

FIG. 1 shows a perspective view of a prior art tumbler pin lock;

FIG. 2 shows a cross-sectional view of the lock of FIG. 1, taken along its longitudinal axis;

FIGS. 3a, 3b and 3c show an assembled front view of the device of the present invention (FIG. 3a), an assembled side view of the device of the present invention (FIG. 3b) and an assembled top view of the device of the present invention (FIG. 3c);

FIG. 4 shows an exploded view of the components of the device of the present invention;

FIGS. 5a and 5b show an enlarged front view (FIG. 5a) and top view (FIG. 5b) of a pin stopper of the present invention with a hole bored therein;

FIG. 6 shows a guide tool for use with the present invention; and,

FIGS. 7a, 7b and 7c show the process of removing a pin stopper from its chamber using the device of the present invention.

### DETAILED DESCRIPTION OF THE PREFERRED EMBODIMENTS

A conventional pin tumbler lock may malfunction in a variety of ways. One example of a common malfunction is when one element of a pin stack becomes jammed within its chamber. When this occurs, a locksmith will typically recommend replacing the tumbler lock instead of attempting to repair it due to the difficulties involved. The present invention provides a novel method of enabling a chamber jam to be easily repaired from a conventional prior art lock housing.

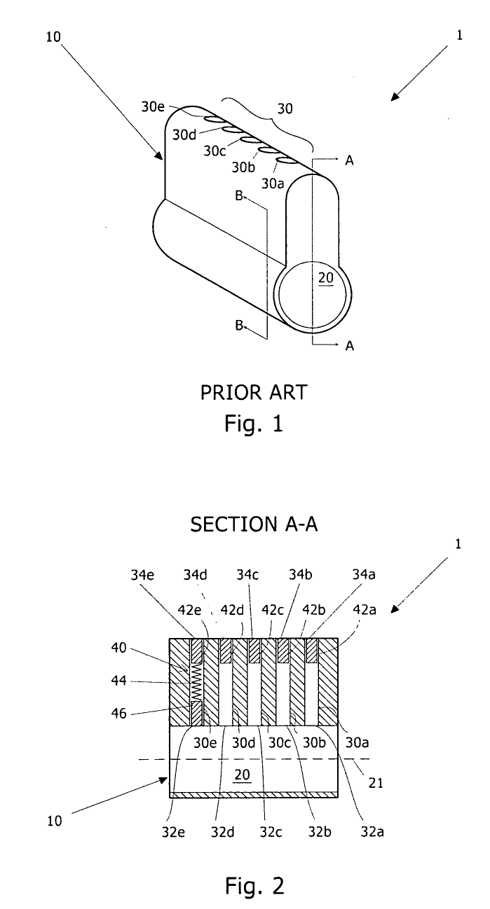

Referring to FIG. 1, a conventional prior art pin tumbler lock (1) has a housing (10) comprising a cylindrical bore (20), in which a lock plug (not shown) is disposed when the pin tumbler lock is fully assembled, and a series of chambers (30), wherein in each chamber (30a-30e) is disposed a pin stack (not shown in this figure) when the pin tumbler lock is fully assembled. It should be noted that the orientation of a tumbler lock within a door is typically (although not necessarily) in a manner such that the cylindrical bore portion is vertically above the narrower portion of the housing, with respect to the ground (i.e. a 180 degree rotation of what is shown in the figures). However, for the purposes of clarity in the illustrative depiction of the present invention, the housing is oriented as shown.

A cross-sectional view of housing (10) of FIG. 1 is taken along its longitudinal axis, and shown in FIG. 2, illustrating stopper pins (42a-e) disposed within corresponding chambers (30a-e). As is seen in the figure, the series (or, row) of chambers (30) runs essentially parallel to the longitudinal axis (21) of cylindrical bore (20). Each chamber (30a-e) radially extends from cylindrical bore (20) through housing (10). A first end (32a-e) of each chamber (30a-e) opens to cylindrical bore (20) and a second end (34a-e) of each chamber (30a-e) opens to the outside of housing (10). As mentioned herein above, when lock (10) is fully assembled a pin stack is disposed within each chamber (30a-e).

One chamber (30e) is shown in the figure, as an illustrative example, with a pin stack (40) disposed therein. Pin stack (40) in chamber (30e) comprises a stopper pin (42e) a spring (44) and a driver pin (46), although additional and/or alternative components may be included in other pin stacks according to the present invention.

As mentioned herein above, the present invention enables easy repairing of a tumbler lock malfunction, particularly one that occurs due to a jam of pin stack components in a chamber. In a conventional prior art tumbler lock housing, it is not easy to access the chambers via the cylindrical bore. Hence, any blockage that occurs in the chamber is very difficult, if at all possible, to clear. It is more time and cost efficient for a locksmith to replace the lock than to spend the time attempting to repair it. The present invention provides an alternate access to the chamber, via the second end of the chamber, thereby bypassing the cylindrical bore. This allows the locksmith to easily repair the malfunctioned lock, and save the customer money in the process.

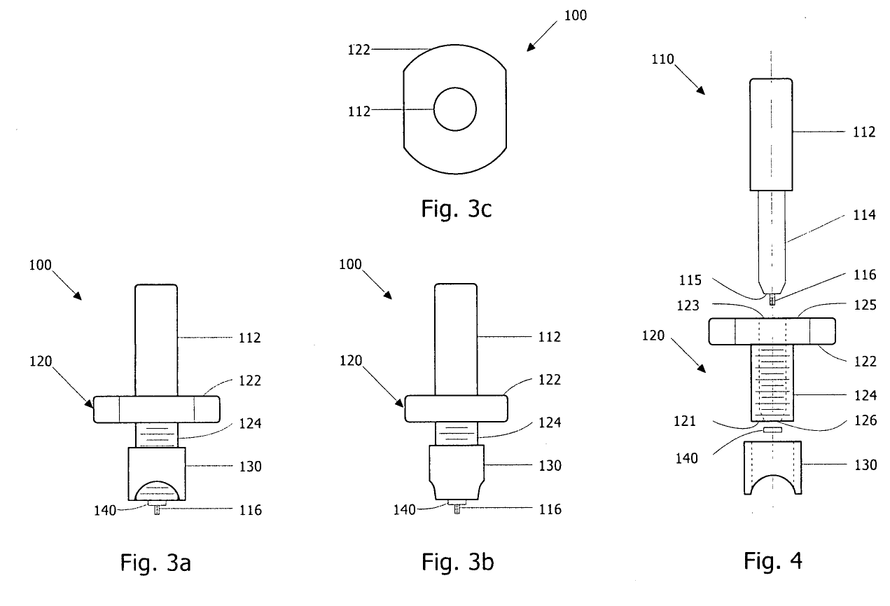

A preferred embodiment of the pin remover device of the present invention, generally designated by numeral (100), is shown in an assembled front view in FIG. 3a, in an assembled side view in FIG. 3b, in an assembled top view in FIG. 3c and in an exploded front view in FIG. 4. With reference to FIGS. 3a, 3b, 3c and 4 as appropriate, pin remover (100) comprises an elongated shaft (110) (see FIG. 4) comprising a proximal handle portion (112) a central portion (114) and a threaded distal tip (116) (insertion component). Central portion (114) of shaft (110) is disposed within hollow screw (120), and is rotatable freely about its axis. Hollow screw (120) comprises a head portion (122) for gripping and rotating, and a body portion (124) having an outer surface with external threading. Head portion (122) of the present invention comprises opposing truncated sides (as best seen in FIG. 3c) for aiding the user when gripping, however no truncated sides may be present in some embodiments, or alternatively, the periphery of head portion (122) may comprise a hexagonal nut shape. A lock saddle (130) having internal threading is positioned along body portion (124) of hollow screw (120). A nut (140), having an outer diameter larger than the diameter of the opening (126) at the distal end (121) of hollow screw (120) is positioned around threaded tip (116), to prevent shaft (110) from sliding through distal end (121) of hollow screw (120). The diameter of handle portion (112) is larger than the opening (123) at the proximal end (125) of hollow screw (120), to prevent shaft (110) from sliding through proximal end (125) of hollow screw (120).

As mentioned herein above, the present invention enables the unblocking of a pin stack jam in one of the chambers of a lock housing. This is performed by utilizing the device of the present invention to remove the pin stopper from the second end of its chamber.

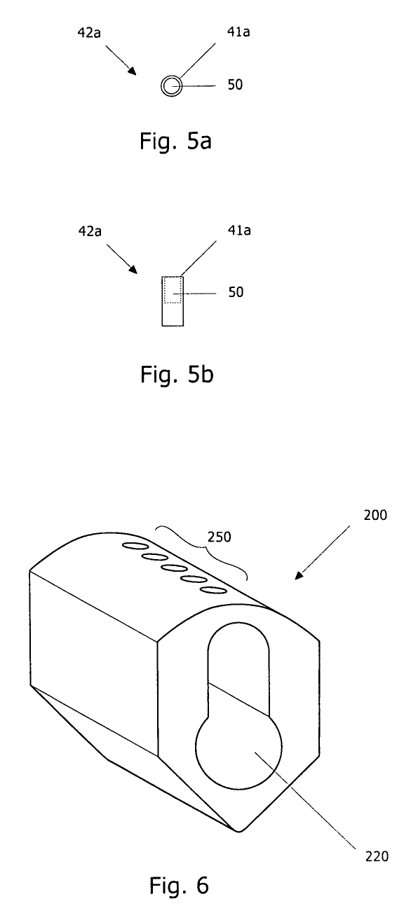

Referring to FIGS. 5a and 5b, in order to remove a pin stopper (42a) (shown enlarged for illustrative purposes) from its chamber (30a) (see FIG. 2) using the present invention (100), a hole (50) must be first drilled in pin stopper (42a) while disposed in chamber (30a). Hole (50) is drilled longitudinally at the longitudinal end (41a) of pin stopper (42a) which is essentially planar with second end (34a) (see FIG. 2) of chamber (30a), open to the outside of housing (30). Hole (50) is drilled to a depth of at least a portion of the longitudinal length of pin stopper (42a). Preferably, hole (50) is drilled half way through pin stopper (42a), though in some embodiments, hole (50) may be less than or greater than half way through pin stopper (42a), and in some embodiments, hole (50) may extend entirely through pin stopper (42a). Hole (50) is threaded internally, to receive threaded tip (116) of shaft (110) of device (100), as described further, herein below.

It is understood that pin stopper (42a) and hole (50) are shown as examples for illustrative purposes, and that a similar hole is required to be bored in each of the additional pin stoppers (42b-e) of lock housing (10).

When it is desired to drill in a surface having a rounded curvature (such as that of longitudinal end (1a) of pin stopper (42a)), it is helpful to utilize a means for guiding the drill bit to the point on the surface at which the drilling is desired, to prevent slippage. Thus, in order to drill hole (50), it is preferable to utilize a guide tool, such as that described in U.S. patent application Ser. No. 12/365,904, by the same inventor as the present invention, and shown in FIG. 6 herein. Tool (200) comprises a receiving cavity (220) in which a conventional prior art tumbler lock housing may be disposed, and at least a series of channels (250) for aligning with the corresponding openings at the second end of the chambers of a lock housing, as described herein above, when the lock housing is disposed within receiving cavity (220). Other features and elements of tool (200) as described in U.S. patent application Ser. No. 12/365,904 are not necessary for use as a guiding tool, and therefore not described herein or depicted in the figure. Alternatively, any other guide tool or means for preventing slippage during drilling of the pin stopper may be used.

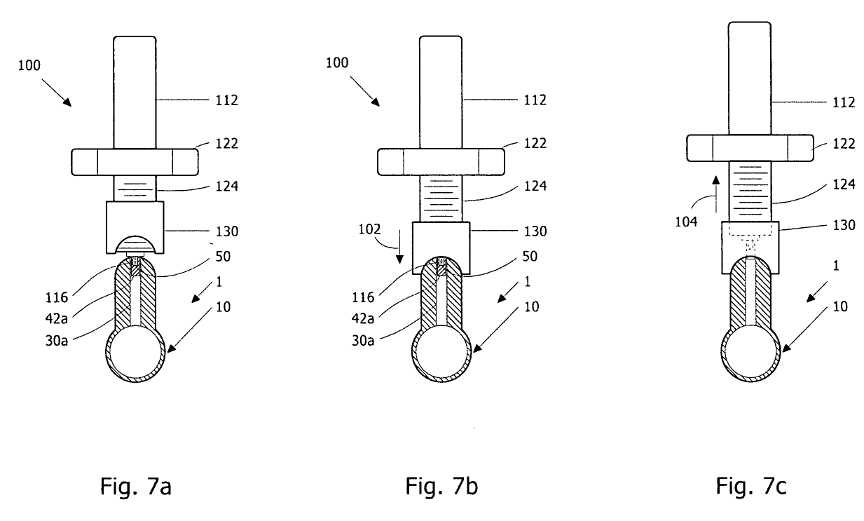

In order to remove pin stopper (42a) using the device of the present invention, the following steps are taken, as described herein below, and depicted in FIGS. 7a-7c, showing a cross-section of housing (10) taken along chamber (30a) in FIG. 1, having pin stopper (42a) positioned at the upper end thereof: First, a suitable hole (50) is bored in pin stopper (42a), as described herein above. Second, with reference to FIG. 7a, threaded distal tip (116) is inserted into threaded hole (50). Housing (10) is maintained in a fixed position, and handle portion (112) is rotated (clockwise, in the preferred embodiment) until tip (116) is tightly threaded in hole (50) (typically until tip (116) is entirely inserted in hole (50) and/or until the free end of tip (116) contacts the bottom of hole (50)). Third, with reference to FIG. 7b, lock saddle (130) is oriented to enable its curvature to saddle housing (30). Housing (30) is fixedly held and lock saddle (130) is maintained in its saddling orientation (for instance, with one's left hand) while head portion (122) is rotated (clockwise, in the preferred embodiment). Lock saddle (130) is reversedly threaded on body portion (124), thus when head portion (122) is rotated in a first direction (e.g. clockwise), lock saddle (130) shifts along body portion (124) towards distal tip (116), as indicated by arrow (102) in FIG. 7b. Head portion (122) is rotated until lock saddle (130) contacts housing (10) and “saddles” housing (10) around chamber (30a), as seen in FIG. 7b. Finally, with reference to FIG. 7c, lock saddle (130) and housing (30) are fixedly held together, while head portion (122) is continued to be rotated (clockwise, in the preferred embodiment). Since lock saddle (130) and housing (30) are fixedly held in place, the rotation of head portion (122) in a first direction (e.g. clockwise) causes body portion (124) to shift through lock saddle (130) as indicated by arrow (104) in FIG. 7c. This creates a torque force, which enables pin stopper (42a) to be pulled out of chamber (30a) while being threaded on distal pin (116), through the upper end of chamber (30a).

Once the stopper pin is removed from its chamber, access to the chamber may be achieved via the second opening of the chamber. Repair may be performed, by, for instance, removing the components of the pin stack contained in the chamber either through the second opening, or by pushing the components out of the first opening and removing them via the cylindrical bore.

It is understood that the above description of the embodiments of the present invention are for illustrative purposes only, and is not meant to be exhaustive or to limit the invention to the precise form or forms disclosed, as many modifications and variations are possible. Such modifications and variations are intended to be included within the scope of the present invention as defined by the accompanying claims.

1. A pin remover device for removing a pin stopper from the upper end of its chamber in a lock housing, wherein said pin stopper comprises a hole bored from the end of said pin stopper open to the outside of said housing, at least partially along its longitudinal axis, said device comprising a mechanism comprised of an insertion component for inserting into said hole, and for removing said pin stopper from said chamber.

2. A pin remover device according to claim 1, wherein the hole comprises internal threading and the insertion component comprises external threading.

3. A pin remover device according to claim 2, wherein the mechanism of said device comprises:
a. an elongated shaft comprised of:
i. a proximal handle portion;
ii. a central portion; and,
iii. a threaded distal tip;
b. a hollow screw in which said central portion is disposed, said hollow screw comprising:
i. a head portion for gripping and rotating; and,
ii. a body portion having an external threading;
c. a lock saddle having internal threading for positioning along said body portion of said hollow screw; and,
d. a nut positioned around said distal tip, for preventing said shaft from sliding through said hollow screw;
wherein said threaded distal tip is the insertion component for inserting into the hole in the pin stopper.

4. A device according to claim 3, wherein the diameter of the handle portion is larger than the internal diameter of the hollow screw, to prevent the shaft from sliding through said hollow screw.

5. A device according to claim 3, wherein the proximal handle portion, the central portion and the threaded distal tip of the elongated shaft are manufactured as a single integral component.

6. A device according to claim 3, wherein the central portion of the shaft is freely rotatable within the hollow screw.

7. A device according to claim 3, wherein the body portion of the hollow screw has counter-clockwise external threading.
